(19) United States
(12) Patent Application Publication
(10) Pub. No.: US 2012/0310862 A1
(43) Pub. Date: Dec. 6, 2012

(54) OPERATION AND MANAGEMENT OF PROFESSIONAL SPORTS TEAM

(76) Inventor: Michael J. Hancock, Springfield, MO (US)

(21) Appl. No.: 13/149,876

(22) Filed: May 31, 2011

(51) Int. Cl. G06Q 90/00

(52) U.S. Cl. 705/500

(57) ABSTRACT

A method of compensating players of a professional sports team subject to a total team compensation restriction. The method includes discounting the amount that at least one player's compensation counts toward total team compensation subject to the restriction, based at least in part upon the length of the player's tenure with the team.

### BACKGROUND

This invention relates to the operation and management of professional sports teams, and in particular, to methods of compensating players on professional sports teams.

The compensation of players for professional sports teams presents difficult questions for sports teams, who need to balance the desire to field a competitive team, the desire to satisfy fans in attracting and retaining favorite players, and the desire to make a profit. Because the resources of teams in a league can vary significantly, in order to provide a “level playing field” that allows all teams to be competitive, some leagues have adopted salary caps or other schemes for giving teams essentially the same resource with which to compete for players. While largely successful in maintaining a competitive league, these schemes add additional constraints and issues for player compensation. In particular, these schemes make it difficult for teams to keep senior players, and particularly long tenured players near the ends of their careers. This is disappointing for fans who become attached to these players because of their long tenure, and who are loathed to see their favorite players end their careers at another team.

### SUMMARY

The present invention relates to methods of compensating players of professional sports teams, and in particular, to sports teams subject to team salary restrictions, such as salary caps. Generally, a preferred embodiment of a method in accordance with the principles of this invention comprises reducing the amount of compensation of at least some of a team's players that is applied to the salary restriction, based on the player's tenure with the team. In one preferred embodiment, where the team is subject to a total salary cap, the amount of each player's salary that applies toward the cap is reduced according to a predetermined scheme based upon how long the player has played for the team. In effect, this allows teams with more tenured players to spend more than teams with less tenured players, rewarding teams that keep players. While particularly applicable to salary caps, the methods of this invention can be applied to any league structure where total team compensation.

### DETAILED DESCRIPTION

In accordance with a preferred embodiment of this invention, a method of compensating players in a professional sports team subject to a salary cap or other collective compensation restriction is provided. In the case of a salary cap, where the sum of all of the individual players salaries attributable to a given year must be less than or equal to some cap number. In accordance with the principles of the present invention the amount of at least some of the players' compensation attributable to the current year are discounted based upon the length of the player's tenure with the team for purposes of computing compliance with the salary cap. This discount preferably increases with the increasing tenure of the player, preferably until a predetermined maximum. This compensation can include salary, bonuses, and/or other benefits.

TABLE 1

| PLAYER TENURE | DISCOUNT FOR CALCUATION OF |
|---|---|
| WITH TEAM | COMPLIANCE WITH SALARY CAP |
| 0 to 2 years | 0% |
| 3 years | 5% |
| 4 years | 10% |
| 5 years | 15% |
| 6 years | 20% |
| 7 years | 25% |
| 8 years | 30% |
| 9 years | 35% |
| 10 years | 40% |
| 11 years | 45% |
| 12 or more years | 50% |

Thus, in accordance with Table 1, 100% of the salaries of players with tenures of 2 years or less are charged against the salary cap; only 95% of the salaries of players with tenures of 3 years are charged against the salary cap; only 90% of the salaries of players with tenures of 4 years are charged against the salary cap; only 85% of the salaries of players with tenures of 5 years are charged against the salary cap; only 80% of the salaries of players with tenures of 6 years are charged against the salary cap; only 75% of the salaries of players with tenures of 7 years are charged against the salary cap; only 70% of the salaries of players with tenures of 8 years are charged against the salary cap; only 65% of the salaries of players with tenures of 9 years are charged against the salary cap; only 60% of the salaries of players with tenures of 10 years are charged against the salary cap; only 55% of the salaries of players with tenures of 11 years are charged against the salary cap; only 50% of the salaries of players with tenures of 12 or more years are charged against the salary cap. This gives a team more room with a salary cap or other salary restriction based upon the team's ability to retain veteran players. Of course, Table 1 is just an example of one possible scheme for discounting salaries based upon tenure, and some other scheme could be used without departing from the invention. For example the discount could have no maximum, or it could reach a maximum earlier or later. Further, the discount does not have to increase by the same amount each year, and thus the changes from year to year could be smaller for the earlier years and greater for the later years, or vice versa.

In some embodiments tenure with the team is calculated based only on a players most recent tenure with the team, in other embodiments tenure with the team is calculated based on the players total number of years with the team, regardless of intervening years with other teams.

While in the preferred embodiments described herein, the compensation is salary, the term compensation could alternatively be, or include, bonuses, benefits, or other remuneration to the player, depending upon what types of compensation the particular league caps.

While in the preferred embodiments described herein, the tenure is described as being measured in years or seasons, tenure could be measured on some other basis, for example number of games attended or played.

Table 2 shows a hypothetical team of 20 players operating under a $36,000,000 salary cap:

| | | | Salary for | |
|---|---|---|---|---|
| | Tenure | Actual | Purposes | Savings |
| Player | with Team | Salary | of Cap | Under Plan |
| Player 1 | 1 year | $500,000 | $500,000 | $0 |
| Player 2 | 1 year | $750,000 | $750,000 | $0 |
| Player 3 | 1 year | $2,000,000 | $2,000,000 | $0 |
| Player 4 | 2 years | $1,250,000 | $1,250,000 | $0 |
| Player 5 | 2 years | $850,000 | $850,000 | $0 |
| Player 6 | 3 years | $1,500,000 | $1,425,000 | $75,000 |
| Player 7 | 3 years | $2,000,000 | $1,900,000 | $100,000 |
| Player 8 | 3 years | $1,000,000 | $950,000 | $50,000 |
| Player 9 | 4 years | $1,500,000 | $1,350,000 | $150,000 |
| Player 10 | 5 years | $1,500,000 | $1,275,000 | $225,000 |
| Player 11 | 5 years | $2,000,000 | $1,700,000 | $300,000 |
| Player 12 | 6 years | $4,000,000 | $3,200,000 | $800,000 |
| Player 13 | 7 years | $3,000,000 | $2,250,000 | $750,000 |
| Player 14 | 7 years | $4,000,000 | $3,000,000 | $1,000,000 |
| Player 15 | 7 years | $5,000,000 | $3,750,000 | $1,250,000 |
| Player 16 | 8 years | $2,500,000 | $2,000,000 | $500,000 |
| Player 17 | 10 years | $4,000,000 | $2,400,000 | $1,600,000 |
| Player 18 | 10 years | $3,000,000 | $1,800,000 | $1,200,000 |
| Player 19 | 12 years | $3,500,000 | $1,750,000 | $1,750,000 |
| Player 20 | 13 years | $2,500,000 | $1,250,000 | $1,250,000 |
| | | $46,350,000.00 | $35,350,000.00 | $11,000,000.00 |

The hypothetical team is paying actual salaries of $46,350,000, but with the discounts according to the preferred embodiment of the present invention, the team is still below the $36,000,000 by $650,000, the team receiving a total of $11,000,000 in relief from the salary cap because of the tenure of the individual players, or a 23.7% discounting of its actual payroll. This hypothetical team has an average tenure of 5.2 years. An alternative way of implementing the methods of this invention is to apply the discount based upon the average tenure of the players on the team, rather than the individual tenures of the players.

Examples showing the application of one embodiment of this method to the National Football League teams for each of the 2007, 2008, and 2009 seasons is attached as an Appendix. If the method were implemented, various teams would be able to expend additional amounts, the salary cap not withstanding, based upon the

[symbol]

Of course other adjustments can be made, for example weighting certain positions differently than others, or applying different discounts to teams based upon past performance, attendance, revenue, etc.

What is claimed is:

1. A method of compensating players of a professional sports team subject to a total team compensation restriction, the method comprising discounting the amount that at least one player's compensation counts toward total team compensation, based at least in part upon the player's tenure with the team.

2. The method according to claim 1 wherein the amount of the discount is determined based upon a formula.

3. The method according to claim 1 wherein the amount of the discount is determined based upon a table.

4. The method according to claim 1 wherein the tenure of the player is determined based solely on the player's current tenure with the team.

5. The method according to claim 1 wherein the tenure of the player is determined based upon the player's total tenure with the team.

6. The method according to claim 1 wherein the discount varies from team to team.

7. The method according to claim 1 wherein the discount is applied to the total team compensation based upon the average tenure of the players on the team.

8. The method according to claim 1 wherein the discount is to the individual player's salaries based on the individual player's tenure with the team.
